(19) United States
(12) Patent Application Publication
(10) Pub. No.: US 2015/0134471 A1
(43) Pub. Date: May 14, 2015

(54) ORGANIZATION AND CONTRACT SCORING FOR PROCUREMENT OPPORTUNITIES

(71) Applicant: Poplicus Inc., San Francisco, CA (US)

(72) Inventors: Geoffrey Brookner Celhar, Moorestown, NJ (US); Eric Troy Gillespie, San Francisco, CA (US); Eric Eugene Schatz, Seattle, WA (US); Hyun Wook Nam, San Francisco, CA (US)

(73) Assignee: POPLICUS INC., San Francisco, CA (US)

(21) Appl. No.: 14/076,760

(22) Filed: Nov. 11, 2013

(51) Int. Cl. G06Q 30/06

(52) U.S. Cl. CPC G06Q 30/0621
USPC 705/26.5

(57) ABSTRACT

A system and method are provided for analyzing government procurement activities based on scores calculated for a customer, fulfilling organization and complexity of each procurement opportunity (e.g., contract) involved. The customer score is based on the number of opportunities and awards provided to the marketplace. The fulfilling organization score is based on the number of opportunity awards won and the frequency and recency of awarded opportunities. Compensation for the award also can be factored into customer and fulfilling organization scores. The complexity score is generated for each opportunity and is based on various attributes of the opportunity, e.g., associated industries, description, life cycle, etc. A user interface is provided for customers and fulfilling organizations to view analytics for procurement activities in each industry and contact information for each customer and fulfilling organization within the system.

### BACKGROUND

Government spending comprises more than 40% of the gross domestic product. In 2012, almost $2.5 trillion dollars was spent by federal, state and local governments on industries such as health care, education, defense, transportation and protection. Government agencies in each industry solicit services through procurement opportunities that are awarded to various competing businesses. These government contracts often are awarded based on past use of a business and/or based on the size and reputation of a business in that marketplace. Such award occurs not only because the lack of transparency in the government marketplace, but the general lack of knowledge about how to obtain those opportunities effectively.

Currently, various services exist that compile government procurement opportunities and allow the procurement opportunities in the government marketplace to be searched. However, the search results for available opportunities typically only provide a business with the size and description for a particular opportunity, the name of companies bidding on the opportunity and, possibly, one or more contacts for that opportunity. Based on this limited information, a business may incorrectly assess its ability to actually be awarded an opportunity when placing a bid, or a government agency may incorrectly assess a business evaluating or placing a bid. For example, it may not be apparent that a business is almost always awarded contracts from the particular agency offering the procurement opportunity. Without the aforementioned information, a business may concentrate too much time and effort pursuing an opportunity that is unlikely to be awarded to the business, or a government agency may make a bad decision based upon faulty assumptions about a business, leading to waste, graft, fraud, or corruption.

Accordingly, it would be advantageous for businesses to gain insight into both past and present government procurement activities in order to leverage knowledge of the government marketplace and more effectively pursue procurement opportunities within that marketplace.

### BRIEF DESCRIPTION OF THE DRAWINGS

FIG. 1 illustrates an environment in which a procurement scoring system operates for analyzing and scoring government procurement opportunities in various industries.

FIG. 2 illustrates a computer system on which the procurement scoring system operates to analyze and score government procurement opportunities in various industries.

FIG. 3 is a flow diagram of a process performed by the procurement scoring system to determine a customer score for a government agency and a complexity score for a contract for a procurement opportunity.

FIG. 4 is an exemplary screenshot of a customer profile with a customer score for a government agency that is generated by the procurement scoring system.

FIG. 5 is an exemplary screenshot of an opportunity profile for a government procurement opportunity with a complexity score that is generated by the procurement scoring system.

FIG. 6 is a flow diagram of a process performed by the procurement scoring system to determine a fulfilling organization score for a business competing for a government procurement opportunity.

FIG. 7 is an exemplary screenshot of a fulfilling organization profile with a fulfilling organization score for a business competing for a government procurement opportunity that is generated by the procurement scoring system.

FIG. 8 is an exemplary screenshot of the procurement scoring system analytics overview, providing procurement opportunity, customer, fulfilling organization and industry-specific summaries.

FIG. 9 is an exemplary screenshot of search results for open opportunities that is generated by the procurement scoring system.

### DETAILED DESCRIPTION

A system and method is provided for generating scores associated with various organizations that participate in government procurement activities. The scores are associated with various participants involved in those activities or aspects of the activities, such as granting organizations providing contracts or grants, fulfilling organizations competing for contracts or grants, as well as the actual contracts or grants awarded through those activities. The granting organizations can include government agencies from which a particular contract or grant opportunity originates, and the fulfilling organizations can include individual contractors and businesses competing for the contracts and grants. The system generates scores that represent various aspects of the available opportunity, e.g., contract or grant. Each of the scores can be generated based on current data for a specific opportunity and the historical data for similar opportunities and/or the organizations involved in the similar opportunities. Moreover, each of the scores can be generated so that they are specific to a particular industry, a particular segment of an industry, a specified time frame, to a particular geography, a particular classification (e.g., NAICS, PSC/FSC, NIGP) or to any other parameter that may be used to segment the scored organization, grant, or contract.

A granting organization providing a contract or grant opportunity is referred to herein as the “customer.” Customers can include various federal and state agencies within a government, such as the Department of Sanitation, the Department of Defense, etc. In some embodiments, customers can also include local organizations, such as non-profits, educational institutions and/or other local government funded organizations. Customers are scored by the system based on various attributes associated with the particular customer along with various attributes within the particular industry in which the customer provides procurement opportunities. For example, the attributes can include the number of procurement opportunities available (both current and historically), the records of past awards for offered opportunities, the cycle time between offer and grant of opportunities, etc.

A fulfilling organization interested in the contract or grant opportunity can include various businesses and/or individuals capable of providing a procured service. For example, a fulfilling organization can include an international bank, a mid-size regional construction company, a local computer programmer, etc. The fulfilling organizations are scored by the system based on various attributes associated with the fulfilling organization's procurement activity that are monitored by the system, and other information associated with industry. For example, the size, location and procurement history of a fulfilling organization can be used by the system for purposes of scoring the fulfilling organization. The fulfilling organization's procurement activity can include both current and historical activity, such as the number and identities of opportunities under current bid, the frequency of successful bidding and magnitude of contracts awarded, etc.

The system may also generate scores associated with the contracts and grants involved in the procurement activity and the corresponding awards given for the procurement activity. Awards refer to any agreements or contracts, as well as any payments or transactions pursuant to such agreements or contracts, between the fulfilling organization and the customers for opportunities won in the marketplace. Contract and grant opportunities may be analyzed by the system using various attributes of the contract or grant, such as size of the contract/grant description, monetary amount awarded, resource requirements, completion times, etc. Additionally, the industry associated with a particular contract or grant may be used by the system to calculate the score. A complexity score is generated by the system using the attributes to estimate the complexity of the underlying task or project. The complexity score can be utilized by the fulfilling organizations to determine whether or not to participate in that particular procurement opportunity. For example, if an opportunity includes a contract with a complexity score of 89, then a fulfilling organization that usually handles contracts with a complexity score of 20-40 may not wish to pursue that contract. In some embodiments, the complexity score may also be used by the system to calculate an aggregate complexity score for the customer or fulfilling organization by analyzing all opportunities that are associated with each customer or fulfilling organization and calculating a complexity score that reflects all opportunities for that customer or fulfilling organization. For example, analyzing all opportunities for a particular customer may include analyzing the opportunities for a parent entity (e.g., government agency) along with the opportunities for each associated subsidiary (e.g., sub-agency of the government agency). While each of the parent entity and the subsidiary still have independent complexity scores, the calculation of each score may contribute to the generation of one another.

By generating scores for each of the organizations, the system provides better visibility into procurement activities based on the historical data associated with each agency, industry, fulfilling organization, etc. which is reflected in the scores given to each of the organizations involved. Utilizing the generated scores, fulfilling organizations are also able to perform better searches on opportunities, evaluate those opportunities, and select opportunities. Although the system is designed primarily for fulfilling organizations to have a transparent view of government procurement opportunities, the system can additionally be utilized by customers to obtain information regarding the fulfilling organizations bidding on a contract as well as identify other trends within the industry.

Accordingly, fulfilling organizations can be provided with the intelligence to execute a well-informed government market strategy by reviewing industry-specific analytics based on data sourced from federal, state, and local organizations. The system allows organizations to leverage unique insights to aid both the customer and the fulfilling organization to determine the best match for an opportunity.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

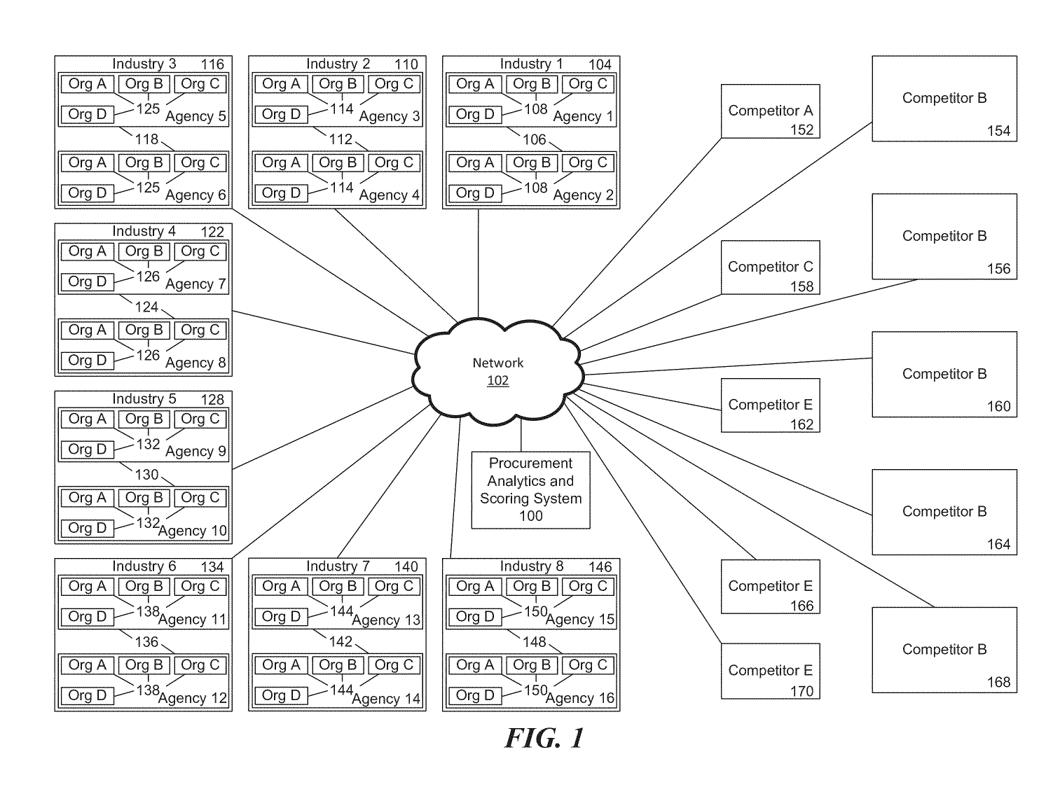

FIG. 1 is an overview of an environment in which a procurement scoring system 100 operates. The environment includes various network communication channels 105, such as the Internet or other public or private networks, through which data can be received and transmitted by the system, and through which users may access the system and utilize system data and analytics. Different constituencies of organizations provide data to the system and access the system. The system 100 interacts with various government agencies, departments, services, and other organizations (each a “customer” 110) which, as depicted in FIG. 1, may be categorized into various industries 115. The system 100 also interacts with a plurality of fulfilling organizations 120, which may utilize the system to review grants and opportunities that are offered by the customers 110.

The data on procurement opportunities that are received by the system 100 may be segmented by the system into various industries 115 to facilitate later analysis. For example, FIG. 1 depicts eight industries that may represent one segmentation by the system: Business and Financial Services, Energy Water and Environment, Construction and Maintenance, Public Safety and Defense, Governance and Education, Information Technology and Telecom, Transportation and Roads, and Healthcare and Life Sciences. While eight industries are depicted, it will be appreciated that a greater or lesser number of industries may be utilized by the system for purposes of categorization. The system may further segment each industry into sub-industries in order to perform a more nuanced analysis and presentation of data. For procurement opportunities falling outside of the known industries, there can be an “other,” “miscellaneous,” or “unreported” category.

Each customer 110 is assigned to one or more of the industries 115. For example, in FIG. 1, Customer A, Customer B, and Customer C, are each assigned to Industry 1. Customers may be assigned to multiple industries. For example, Customer A is assigned to both Industry 1 and Industry 8. While each customer is depicted in the figure as a single entity, it will be appreciated that a customer can include several different divisions or units that provide the procurement opportunities. For example, the Department of Defense can include various internal organizations, such as the Defense Logistics Agency, U.S. Army, or U.S. Navy, etc.

The eight industries are utilized by the system to categorize procurement opportunities from various customers. The procurement opportunities may be received by the system using push technology or pull technology. For example, the system may periodically scrape government websites or access government databases via application programming interfaces (APIs) and web crawling technology in order to retrieve documentation and information that directly relates to the procurement opportunity, such as procurement records (e.g., awards, solicitations, amendments, contracts, bid results, etc.) that are made publicly available by the government. The system may also retrieve documentation and information that is indirectly related to the procurement opportunity such as agency information (e.g., contacts, locations and agency names), as well as private company information (e.g., financial data, business units, etc.), such as for businesses, interested vendors, and pre-approved vendors. Such searching of federal, state and local government websites or databases for procurement opportunities may occur at scheduled time intervals, e.g., every 12 hours, or in accordance with a schedule of released procurement opportunities from the government (e.g., every third Tuesday of the month) in order to gather the most recent data on procurement opportunities and maintain the currency of the system data. As other example, some government agencies may provide periodic communications of procurements opportunities via email, data file, or physical delivery. The system incorporates such procurement opportunities into its data for analysis when such data is received.

Once obtained by the system 100, the system assesses and categorizes each procurement opportunity. As will be described in additional detail herein, the procurement opportunity is assessed and categorized using information associated with the customer 110 from which it originated, the industry 115 to which it was assigned, but also based on various attributes of the information included in the opportunity itself. For example, the textual data in the procurement opportunity can be searched for keywords in order to determine characteristics of the opportunity and estimate the complexity of the opportunity. The system may score the procurement opportunity based on the analyzed characteristics of the opportunity.

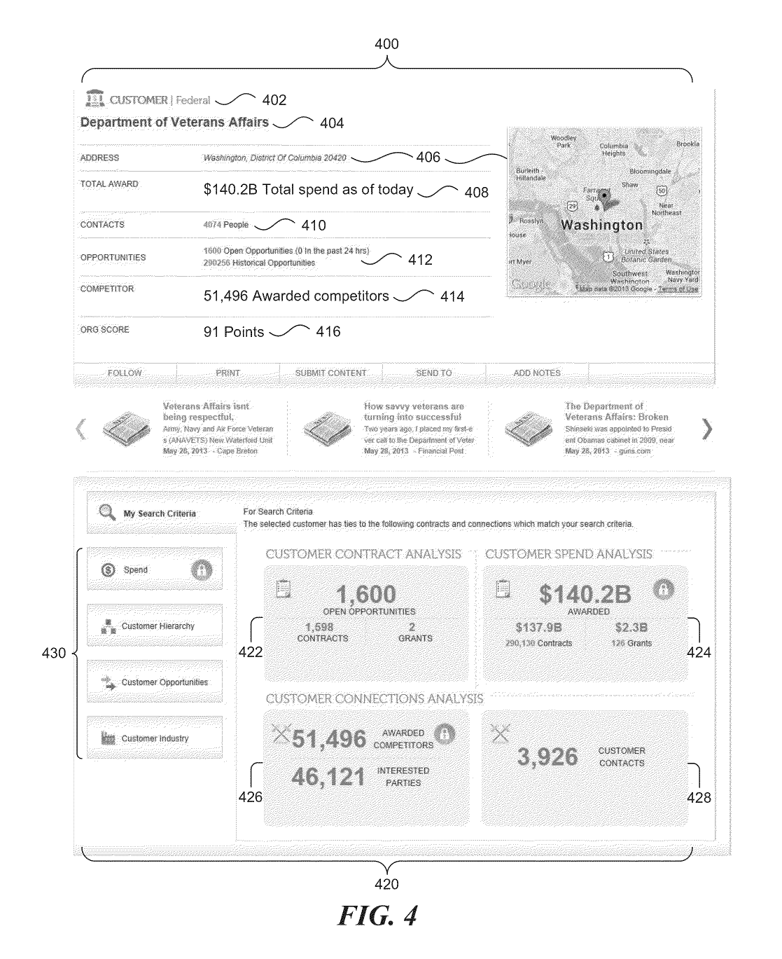

Referring still to FIG. 1, the fulfilling organizations 120 can communicate with the system 100 through an interface, such as a remote computer, to view the various procurement opportunities, as well as any customer and industry analytics provided by the system. Each fulfilling organization 120 can register with the system 100 through the network in order to gain access to the system data. A profile for each fulfilling organization, as well as for each customer and procurement opportunity is created once data for that entity is received by the system. These profiles are further described in the following paragraphs with reference to FIGS. 4, 5 and 7.

One skilled in the art will understand that the functions and features of the system 100 described herein may be implemented by computer-executable instructions that are executed on one or more server computers. It will be appreciated that the disclosed technology can be also practiced with other computer system configurations, including desktops, laptops, multiprocessor systems, microprocessor-based systems, minicomputers, mainframe computers, or the like. The disclosed technology can be embodied in a special purpose computer or data processor that is specifically programmed, configured, or constructed to perform one or more of the computer-executable instructions to implement the functions or features described herein.

The terms “computer” and “computing device,” as used generally herein, refer to devices that have any data processor and non-transitory memory containing instructions that are executed by the processor. Data processors include programmable general-purpose or special-purpose microprocessors, programmable controllers, application-specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical-based disks, flash memory devices, or any other type of non-volatile storage medium or non-transitory medium for data. Software may include one or more program modules, which include routines, programs, objects, components, data structures, and so on that perform particular tasks or implement particular abstract data types.

The disclosed technology can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the technology described herein may be stored or distributed on tangible, non-transitory computer-readable media, including magnetic and optically readable and removable computer discs, stored in firmware in chips (e.g., EEPROM chips). Alternatively, aspects of the invention may be distributed electronically over the Internet or over other networks (including wireless networks). Those skilled in the relevant art will recognize that portions of the system may reside on a server computer, while corresponding portions reside on a client computer in communication with the server computer.

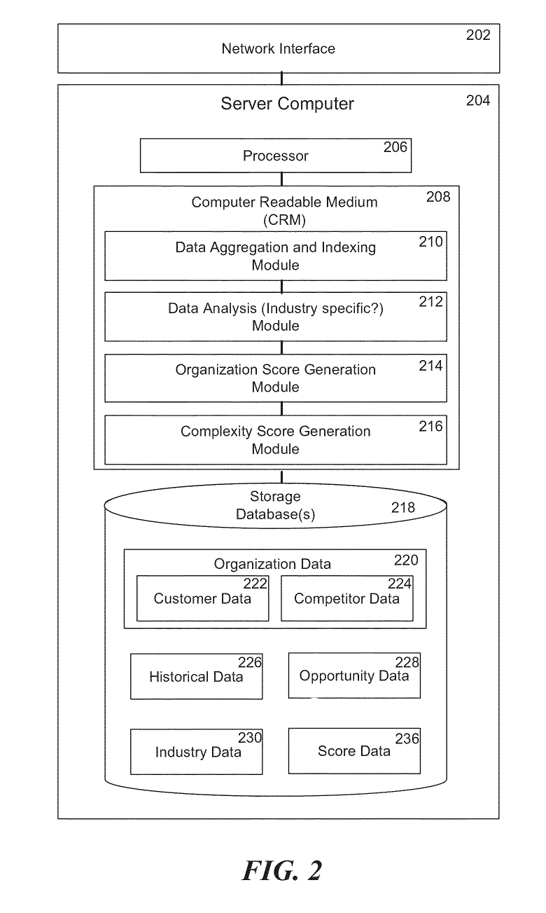

Referring now to FIG. 2, an exemplary computer system 204 on which the procurement scoring system 100 operates is provided. The system 204 includes a non-transitory computer readable medium 208 on which computer readable instructions are encoded for performing an analysis of customer data, procurement opportunity data and fulfilling organization data. The computer readable medium 208 is coupled to one or more processors 206, which operate to execute the stored instructions in order to implement the functionality of each component within the system. In particular, the system 204 includes instructions specifying operations for various modules including, an aggregating and indexing module 210, an analysis module 212, an organization score module 214, and a complexity score module 216. The data aggregated by the system for analysis can be received through a network interface 202 coupled to a public or private network and/or a wired or wireless network.

The aggregating and indexing module 210 receives data from through various communications channels in the network, aggregates the data on the system, and indexes the data based on the various attributes of the data. For example, the aggregating and indexing module 210 can include an application which searches the various federal, state and local government websites for procurement opportunities at set intervals. Information about identified procurement activities is gathered, and the information stored on the system for subsequent use and analysis. The module 210 may analyze and categorize the procurement opportunity data before storing it in various predetermined locations of databases 218 coupled to the system.

The data analysis module 212 uses the stored procurement opportunity data 228 to calculate various analytics based on industry, customer, fulfillment organization, and procurement opportunity. The data analysis module 212 synthesizes the data to provide summaries of the analyzed data in various visual graphics, listings and other reports such that a user of the system can easily access data on the system based on specific attributes of that data. The analysis module 212 further stores the analyzed data in the various data specific locations within one or more databases 218 coupled to the computer readable medium. The analyzed data can be later referenced as historical data 226, for example, when calculating scores for customers, fulfilling organizations and contracts.

The organization score generation module 214 calculates the scores for each of the customers 110 from which procurement opportunities are offered, as well as the fulfilling organizations 120 expressing interest and competing for contracts, grants and other opportunities from those customers. Customer scores are generated based on each procurement opportunity offered by that particular customer. The customer score may be calculated based on all opportunities offered by the particular customer, based on those opportunities offered by the customer that are associated with a particular industry of a fulfilling organization, based on opportunities that match search criteria that is entered by a fulfilling organization, and/or based on other historical industry-specific and opportunity-specific data associated with that customer. Similarly, the fulfilling organization scores are generated by the score generation module 214 and can be based on historical industry-specific data 230 and/or fulfilling organization data 224 including past opportunity bids, losses and awards. In some embodiments, registered users on the system can provide feedback for various customers on the system which can also be utilized to determine the customer score. For example, fulfilling organizations can provide feedback data regarding procurement opportunities awarded to those organizations. The feedback data can be assessed for keywords reflecting various sentiments, each of which can be utilized to weight the organization score. Each of the customer and fulfilling organization scores, e.g., score data 236, can additionally be calculated based on the complexity scores for procurement opportunities offered and won/lost by each of those organizations, respectively.

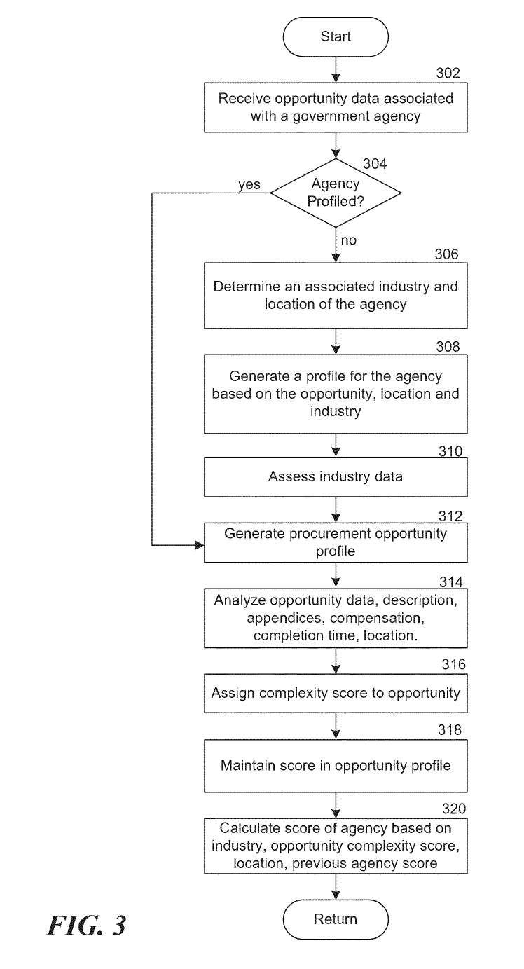

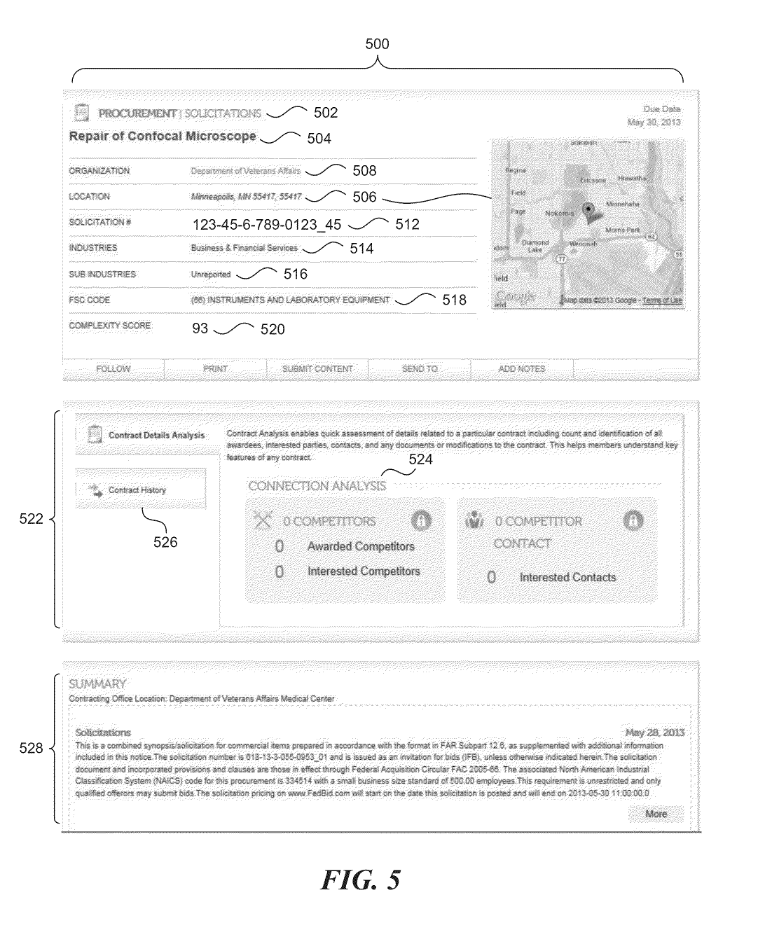

It will be appreciated that because each customer and fulfilling organization score is based on the procurement activities of the government marketplace as well as the activities within that marketplace that are particular to each customer and each fulfilling organization, the scores calculated by the system 100 are dynamic and can vary over time. For example, if a fulfilling organization is new to the marketplace and bids on a low compensation opportunity with a low complexity score, but later bids and wins a high compensation opportunity and a high complexity score, that fulfilling organization's score will increase. Customer and fulfilling organization score generation is further described with reference to FIGS. 3 and 5.

The complexity score generation module 216 calculates the complexity score for each procurement opportunity that is identified by the system. For each opportunity offered through the marketplace, a profile is created which includes a complexity score for the contract or other statement of work associated with that opportunity. The complexity score is based on various predetermined attributes characterizing a contract or statement of work. For example, the attributes can include the length (e.g., word count) of the description of the procurement opportunity, the number of additional documents, word count of the additional documents and the document types appended to the opportunity, the industry associated with the opportunity, the length of time expected for completion of the opportunity, the required manpower (e.g., estimated number of individuals or effort of individuals), the materials required to complete the opportunity (e.g., physical construction using construction equipment or computer services using programmed servers), the agency offering the opportunity, and/or the compensation for the opportunity. Complexity score generation is further described with reference to FIGS. 3-4.

The system 100 can also include various storage databases 218 which store data based on various predetermined attributes. For example, the data received by the system for each customer and fulfilling organization can be stored in an organization data section 220 of the database. This data can include information specific to each organization, such as the information within each organization's profile. For example, the data can include an organization name, contact information, location, current score, organization type, industry, etc. The storage database can also include a historical data database 226, which stores the past procurement opportunity data which is pertinent to calculating scores for each of the customer, fulfilling organization and procurement opportunity. Maintaining historical data of procurement opportunities is important because, once an opportunity is awarded, the details associated with that opportunity may no longer be publicly available. The storage database 220 can further include an industry data database 228 in which industry trends in the analyzed data can be stored. The industry data can additionally be utilized to determine each of the customer and fulfilling organization scores as well as the complexity score for an opportunity. The storage database can further include an opportunity data database 228 that includes a complexity score for each procurement opportunity, as well as attributes of the procurement opportunity such as the industry, compensation, location, copies of the disclosure materials for that opportunity, etc. The storage database 220 can also include a score data database 236 in which each of the scores associated with the customer, fulfilling organization and contract can be stored in a storage database of the system.

FIG. 3 is a flowchart of a process 300 by which the system 100 receives data for a new procurement opportunity that is offered by a customer providing that opportunity. The system can process each new procurement opportunity in a similar manner in order to determine if a particular customer profile should be created or if the opportunity is associated with an existing customer profile that is already maintained by the system. At block 302, the system receives data for a procurement opportunity. The opportunity data can be sourced from various government websites, databases, or other data sources. For example, the data can be scraped by the system from websites or accessed via defined APIs. In other embodiments, the data can be manually entered by a systems operator or by a customer registered with the system.

At decision block 304, once the opportunity data is received by the system, the data is assessed by the system to determine the customer through which the opportunity is being offered. For example, the procurement opportunity data may contain a field that identifies the offering government agency or organization by name, code, or other identifier. Alternatively, a system operator may code or otherwise associate each procurement opportunity with the corresponding customer. If the customer already has a profile that is stored by the system, the system associates the current opportunity data with that customer at block 305. If, however, it is determined that the customer associated with the opportunity data is not known by the system, e.g., no profile for that customer exists, the system begins a process to create a customer profile. At block 306, the system begins generating a profile for the customer by determining an industry in which the customer offers procurement opportunities. The system further determines a location of the customer. At block 308, the system then generates the customer profile. With the industry and location information determined at block 306, the generated profile can include, at the very least, an organization name, location, industry, organization type and additional information associated with the procurement opportunity.

An exemplary screenshot of a customer profile that is generated by the system 100 is illustrated in FIG. 4. As shown in the customer profile, two information windows 400, 420 are provided. The first window 400 includes a marketplace summary of the depicted customer 404. The summary includes a profile heading 402, that can include the type of organization (i.e., “customer”) as well as the type of government entity (federal, state, local). The profile heading 402 allows a fulfilling organization to quickly gauge the level of opportunities offered by that customer. For example, a fulfilling organization may be more inclined to review opportunities associated with the Department of Defense if the fulfilling organization has a history of offering services to the defense industry. The summary also includes the customer name 404, location 406 and industry of the agency (not shown). Additional information known to the system, such as a link to a list of customer contacts 410 and links 412 to both open procurement opportunities and historical procurement opportunities are provided. In addition, the first window includes an indication of a number 414 of fulfilling organizations that have provided service to the customer and an organization score 416 that the system has calculated for the customer 402. When a customer is newly registered with the system, it will typically have few opportunities listed. However, as the length of time that the customer is registered with the system increases, each of these fields, e.g., total award, contacts, opportunities, fulfilling organization, organization score, will typically increase or decrease and become more relevant as more data can be pulled into the system from procurement opportunities offered by that customer. In some embodiments, dependent upon the type of account with which a user is registered on the system, that user may not be able to view various portions of the customer profile.

One or more of the elements within the first window 400 of the customer profile can be included in the calculation of the organization score 416, though the organization score can also be based solely on the awarded opportunities from that customer. The organization score 416 can be calculated based on weighted criteria using known analyzing techniques, such as a recency, frequency and monetary (RFM) analysis technique. Accordingly, the recency of the award given can be a primary factor in the score generated for that customer, which can allow opportunities that were offered by the customer in the previous 6 months to carry more weight in calculating the organization score than opportunities that were offered by the customer more than a year ago. Directly related to the recency is the frequency of procurement opportunities awarded. Customers providing many awards (e.g., 200 per year) may achieve higher scores than those providing few opportunities and subsequent awards in the marketplace (e.g., 2 per year). Finally, the monetary criteria can be factored into the organization score so that organizations providing many low cost opportunities may score lower than organizations providing fewer opportunities at a substantially higher opportunity value.

As will be described in additional detail below, the organization score provides the overall rating of a particular customer based on attributes associated with that customer as compared with other customers tracked by the system. In addition to historical award data, additional attributes can include the number of opportunities being currently offered in the marketplace (or, for vendors, on which open opportunities are being followed and/or bid), the dollar value of the opportunities, and the other factors discussed herein. In some embodiments, the organization score can also depend on the industry with which a particular customer is associated. If the customer is associated with more than one industry, each of those industry associations may be taken into account for that customer. For example, if the customer consistently offered procurement opportunities in the telecom industry and offered 2-3 opportunities in the education industry, the data related to those two industries would be included when determining the customer's score. However, in the aforementioned example, the telecom industry data would be weighted more heavily than the education industry data.

For customers for which a new profile is generated and no data is known within the system, the customer score 416 is not shown, e.g., is null, or shown as “pending”, until an opportunity is awarded to a fulfilling organization and the activity associated with that award is analyzed to determine the customer score, e.g., the number of bids, award amount, number of fulfilling organizations expressing interest, time in marketplace, etc. In some embodiments, the system may generate a score for a customer and/or fulfilling organization after one or more opportunities have been awarded. In other embodiments, a score is generated after a threshold number of opportunities are awarded such that the aggregate data can be analyzed for a mean score. In some embodiment, until a customer awards sufficient opportunities to generate its own score, the customer score 416 for a new customer may be initially set to be a mean industry score for the industry associated with the customer and the complexity of the procurement opportunity being offered. These and other attributes for calculating the customer score are further discussed at block 320. The score within the customer profile may change dynamically with each additional opportunity and award associated with that customer. Furthermore, the score for any particular customer is specific to that customer. The customer data for opportunity activities in the government marketplace, such as the connections (contacts), awarded fulfilling organizations, spend amount, and opportunities available utilized to calculate the customer score are stored by the system in a profile of the customer.

The second window 420 of the customer profile can include additional analytics summarizing the customer's position in the marketplace. For example, the second window 420 can include a customer contract analysis component 422, a customer spend analysis component 424 and a customer connections analysis component 426, including a customer contacts component 428. The customer contract analysis component 422 can include the data related to the opportunities associated with a particular customer. For example, as shown in FIG. 4, the customer has 1,600 open opportunities, including two types: 1,598 contracts and 2 grants. Clicking or otherwise selecting the open opportunities, contracts, or grants will take a user to a respective list of those opportunities, contracts, or grants. Each of the opportunities shown has been analyzed by the system and can be accessed by a fulfilling organization via an opportunities (solicitation) profile. The customer spend analysis component 424 utilizes the historical opportunity data known by the system to determine the dollar amount of expenditures for past contracts and grants associated with the customer. The customer connections analysis component 426 provides a historical view of the number of fulfilling organizations to which contracts and grants were awarded and the number of current fulfilling organizations expressing interest (e.g., following or bidding) on active opportunities in the system. The customer contacts component 428 includes the number of customer contacts for which the system maintains contact information (e.g., a name, email address, phone number). Each of the analytics provided in the second window can be representative of the customer as a whole, or may be filtered to reflect only those aspects of the customer that are pertinent to a search query of a fulfilling organization. For example, a fulfilling organization may only be interested in opportunities in a particular sub-industry segment. If that is the case, the second window 420 of the customer profile may be modified to only include opportunities, spend analysis, expenditures, etc. that are associated with the selected sub-industry. In another example, the fulfilling organization may only be interested in particular geographic region. In that case, the second window 420 of the customer profile may be modified to only reflect customer data associated with the selected geographic region.

The second window 420 of the customer profile also provides quick access to additional inputs utilized to analyze that customer's data and, in some embodiments, calculate the customer score. For example, the second window includes tabs 430 that allow a user to quickly access the customer's historical spend analytics, the customer's organizational hierarchy describing what the customer's organization and parent/children organizations provide, the customer opportunities (current and past) provided in the marketplace, and the industry or industries profile(s) affiliated with that customer. The tabs 430 also include a search tab in which a user can enter specific search criteria to generate analytics associated with that customer that correspond to that search criteria, as described in the previous paragraph. Access to one or more of the features in the second window 420 may be on a paid (subscription or per-use) basis. For example, the lock on the “Spend” button indicates that a user must have a specific account with the system operator in order to access the customer spend data.

Referring back to FIG. 3, at block 310, if the system determines that a customer profile already exists for the customer associated with the procurement opportunity received at block 302, the system associates the opportunities at block 305 and generates a procurement opportunity profile for that opportunity at block 310. The opportunity profile can include any information included in the original solicitation sourced from, e.g., a government website. An exemplary screenshot of a procurement opportunity profile 500 is shown in FIG. 5. The opportunity profile can include a first window 500 including an overview of the details for that opportunity. For example, the opportunity profile can include an indication of the customer 508 through which the opportunity is being offered, a type of opportunity 502 (e.g., solicitation or grant), and a title 504 of the opportunity. Additionally, the opportunity profile can include a government assigned solicitation notice number and coding (PSC Code) 512 or other unique identifier, a location of the opportunity 506, an indication of an industry 514 associated with that opportunity along with any associated sub-industries 516. The industry 514 associated with any given opportunity may differ from the primary industry in which the agency offering the opportunity is associated. In some embodiments, the complexity score 520 for an opportunity is only associated with a single industry and analyzed in accordance with data associated with that industry. In other embodiments, an opportunity complexity score 520 may be analyzed according to more than one industry, similar to the embodiments described for the customer score.

The opportunity profile 500 also includes the aforementioned complexity score 520 for that opportunity. The complexity score 520 is determined for a particular opportunity at the time the opportunity profile is generated. Each solicitation, or opportunity, has a lifecycle including the time from when the opportunity is opened, the time from when opened until modified (if modified), the time from when opened/modified until awarded, and the time after awarded until completed. After an opportunity is opened and until it is awarded, updates, amendments, or other supplemental information (e.g., additional documents, third-party data, news coverage, etc.) can be received by the system which affect the complexity score of the opportunity. Accordingly, the complexity score may change as more data associated with the opportunity is received by the system. For example, in the bidding stage, amendments to, e.g., the workforce needed, work requirements, time until completion, etc., may cause a change in the complexity score of that opportunity. Further, even in the award stage, additional documents corresponding to that awarded opportunity may be received by the system which cause the complexity score for the procurement opportunity to change. The complexity score 520 can also change when particular amendments are made to the procurement opportunity, such as when amendments are made to the supporting documents for that opportunity. The complexity score 520 is based primarily on opportunity data received by the system. The calculation of the complexity score 520 is further discussed at block 314.

A second window 522 in the opportunity profile can include an analysis of the contract details for the opportunity 504 in the opportunity profile. For example, the contract analysis can include an assessment of the details related to a particular contract including a count and identification of all fulfilling organizations awarded (awardees) historically for the contract, fulfilling organizations currently interested in the contract (e.g. currently bidding or flagging the contract), contacts for the contract owner, documents associated with the contract, and modifications to the contract (e.g., addendums, etc.). A connections analysis 524 section provides a visual summary of the current awarded and interested competitors, or fulfilling organizations, and those organization's contacts. A contract history tab 526, when selected, provides a timeline of the opportunity actions (i.e., bidding history) and associated amendments, contracts, awards, etc. for that opportunity.

A third window 528 in the opportunity profile can include a “Summary” of the procurement opportunity. The summary can include the title of the opportunity, the customer (e.g., the contracting government office), and a description of the opportunity found in the originally issued solicitation. A date for the originally issued solicitation may also be provided, although it may not reflect the same date on which the procurement opportunity profile was created on the system.

Returning to FIG. 3, at block 312 the system assesses the current marketplace and the industry specific to the opportunity data received. For example, if there are few to no opportunities offered in a particular industry, the scores for the opportunities may be more heavily weighted. In some embodiments, the industries providing the highest compensation or the quickest turnaround for opportunities may cause a more heavily weighted complexity score for associated opportunities. Each factor analyzed and provided in the industry analytics is utilized to determine the current industry state for purposes of determining the complexity score and organization (customer and fulfilling organization) scores. The industries can be divided into predetermined groups, each group can also be referred to as a vertical. For example, the verticals can include 1) Business and Financial Services, 2) Energy, Water and Environment, 3) Construction and Maintenance, 4) Public Safety and Defense, 5) Governance and Education, 6) IT and Telecommunications, 7) Transportation and Roads, and 8) Healthcare and Life Sciences. Each vertical can further include sub-industries which further define the various sectors of each industry. For example, the IT and Telecommunications sub-industries may include: cyber security, radio and television broadcasting, equipment manufacturing, computer programming, information services, computer design, wireless communications, antenna design, location based services (GPS), and so on. The sub-industry classifications can allow improved searching in the system by providing additional search criteria for a user to locate procurement opportunities in industry specific fields. Accordingly, a fulfillment organization that designs antennas would not have to look through all opportunities available under the IT and Telecommunications industry in order to locate antenna specific solicitations.

At block 314, the various inputs, such as the analytics for the opportunity data, the industry data, the opportunity description 528, location 506, compensation and various other opportunity attributes utilized to calculate the complexity score can be analyzed for a particular procurement opportunity. The specific attributes, for example, can include the word count provided in the description 528 of the procurement opportunity, the industry 514 of the opportunity, keywords located in the description 528, location of the opportunity 506, manpower required to complete the task. For example, an opportunity description 528 having 500 words may be scored less than one having 5,000 words. Additionally, if the original opportunity solicitation includes pictures or attachments, those may be analyzed and cause an increase or decrease in the complexity score of the opportunity. For example, a procurement opportunity, or solicitation may include 5 attachments, each including text and/or images. Each of those attachments can be figured into the overall textual description of the solicitation and corresponding word count along with each image providing additional points to the complexity score.

Additional attributes analyzed for each procurement opportunity can include, for example, data related to the customer, or government agency from which the opportunity is provided. For example, the customer's organization score and procurement history, such as how many solicitations have been issued and awarded. Additionally, feedback provided by fulfilling organizations to a particular customer profile can be analyzed to determine a procurement opportunity's complexity score 520. For example, if an agency providing the opportunity has a poor reputation for and negative feedback for past procurements, then this will increase the complexity of the opportunity as that agency is considered more difficult to work with on a contract.

At block 316, the computer system can assign a complexity score 520 to the procurement opportunity based on the analyzed data. As previously mentioned, the score can be dynamic and can change based on amendments made to the procurement opportunity, e.g., to the time for completion, added documentation, additional workforce required to complete the opportunity, etc. Even if the industry and/or associated customer's score changes over the course of the procurement opportunity offering in the marketplace, however, the complexity score 520 may remain the same. The complexity score 520 can be utilized by the users of the system not only a summarized analytic representing the particular procurement opportunity, but can also be utilized as a search criteria when fulfilling organizations are searching the marketplace. For example, the search may include any opportunities having a complexity score over 80 or below 50, dependent on the type of opportunity desired by the fulfilling organization. Additional search filters can be utilized within the scope of the invention, such as various predefined attributes, verticals, agency name, contact names, etc.

The intake of each opportunity in process illustrated in FIG. 3 ensures that not only is each opportunity properly analyzed and entered into the marketplace, but also that the customer profiles and associated information and the industry specific data are updated with each new opportunity data received by the system. In some embodiments, the system automatically updates at predetermined time intervals, including re-calculating and analyzing the current opportunities in the marketplace. Additionally, each time that a procurement opportunity is awarded, the system can archive the associated procurement data and profile after a predetermined time period such that the data can be utilized in future calculation and analytics illustrating current and past market trends and benchmarks for the various fulfilling organizations in the system.

At block 318, the complexity score 520 can be utilized to update the organization score for the customer providing the procurement opportunity along with any associated organizations, such as the organizations for fulfilling organizations awarded opportunities through that customer or within the industry. Though the addition of a small opportunity, having a low compensation and lower complexity score, may have little effect on the associated organizations, opportunities with high compensations and associated with industries and customers dominating the marketplace, may cause visible increases (or decreases) on organization scores in some embodiments. The organization, such as the government agency providing the opportunity, can be scored on various inputs, similar to the complexity score for the procurement opportunity. However, as discussed previously the organization score can, and usually does, change with the market. The organization score also relies more heavily on the customer data received over time by the system rather than the data received during the initial registration and profile generation of that customer. For example, the industry in which the customer may provide procurement opportunities may increase over time, improving the organization score. Additionally, the number of procurement opportunities awarded, the gross spending of that customer and feedback received from fulfilling organizations cause the organization score 416 to change.

At block 320, both the complexity score 520 for the procurement opportunity and the organization score 416 for the customer are maintained in the respective profiles. The organization score 416 is maintained until at least another opportunity is offered through that customer and/or a system update is performed in which feedback and various other industry and market inputs can be analyzed and calculated to generated an updated score. The complexity score 520 can be maintained in order to calculate scores corresponding to that procurement opportunity and the associated customer 508.

Only knowing the scores of the customer, or government agency, and a particular procurement opportunity is not always useful to the businesses competing for a particular opportunity. Often, those fulfilling organizations need to analyze the businesses with whom they are competing for any given contract. For example, if a new organization (“company A”) that has no score and has never bid before is bidding on a contract against a seasoned organization (“company B”) that has a high score and has won several bids with the contract provider, company A may decide to retract the bid. Alternatively, company A may wish to procure opportunities elsewhere, such as concentrating on a bid against a lesser fulfilling organization (company “C”) that has lost several bids, has bad reviews by customers, etc. Accordingly, assessing all aspects of the market activity associated with that fulfilling organization, provides other fulfilling organizations with a summarized metric of the strength of that fulfilling organization.

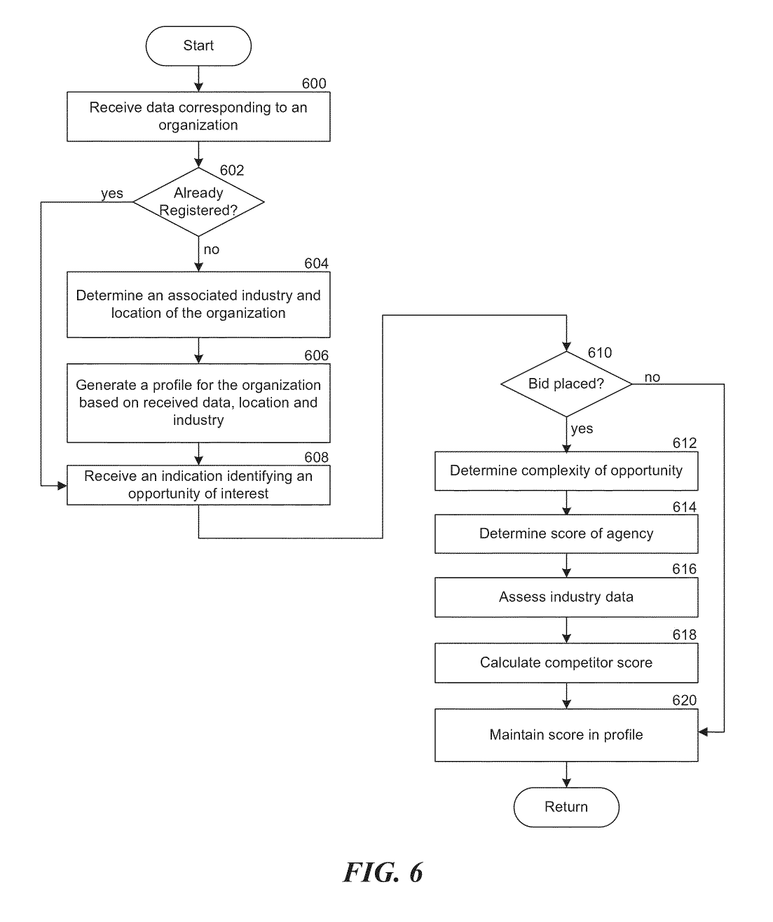

Referring to FIG. 6 a flowchart of a method for determining an organization score for a business competing (“fulfilling organization”) for procurement opportunities in the government marketplace is illustrated. The method can begin when a new fulfilling organization enters the marketplace, e.g., when associated data is received in the system, via a user associated registration process known in the art or via scraping organizational information using a web crawler. The provided or acquired basic company details are stored and assessed by the system in order to generate a profile for that fulfilling organization. In other embodiments, the method can begin when new data associated with that fulfilling organization is provided to the system. For example, if the fulfilling organization wins or loses a bid on a procurement opportunity, or, if the fulfilling organization adds numerous contacts within an associated industry. Further, the new data can be generated by that company and entered into the company profile, such as an increase in the number of employees, associated industry sectors, locations etc., which can occur, for example, if that fulfilling organization acquires a company or opens a new office. Regardless of how the new data is generated, the method begins once the data is received by the system.

At block 600, organization data corresponding to fulfilling organization business in the government marketplace is received. The data can include information describing various attributes of the fulfilling organization. The attributes can be normalized to compare with stored data (e.g., registered fulfilling organization data). One or more of these attributes can be predetermined by the system and can be extracted from the data received and then matched to the organization data. In further embodiments, the system can prompt a user providing the fulfilling organization related data for information relating to a particular attribute. For example, during initial registration, the system can provide numerous predefined fields for the user to enter company related information. In other embodiments, if the system determines that fulfilling organization data has changed, e.g., an opportunity has been awarded, the system can prompt the user associated with that fulfilling organization for details regarding the awarded opportunity, e.g., via email request or other communication means. In yet a further embodiment, in the aforementioned example for an awarded opportunity, the system can automatically update the fulfilling organization data and provide the information relating to those predetermined attributes according to data received from the customer associated with the awarded opportunity. The fulfilling organization data received by the system can include a name of the fulfilling organization and at least one additional piece of information indicating a change in a predetermined attribute.

At block 602, the system determines whether the received fulfilling organization data is associated with a registered fulfilling organization in the system by matching the normalized attributes (e.g., name, email, etc.) of the received fulfilling organization data to the attributes of registered fulfilling organizations. For example, when a user accessing the system via a remote device, such as a personal computer, provides an email address or username in order to log into the system the system can determine if any new company related data provided by the user is going to require an update to that system's profile and, possibly, associated industries and customers. For example, the system creates company profiles derived from opportunity data found via, e.g., a web crawler. Analytics associated with that company can then be added to the company profile and updated each time that a new opportunity is entered in the system. The company profile is therefore created regardless of whether a user associated with the company is registered with the system or not. However, if a user enters a registration process, providing new company data in predefined fields during the registration process, the system can determine that a new profile will need to be created for that fulfilling organization, but no additional system data, such as current industry analytics and customer analytics, will require modification. This is because the new fulfilling organization has yet to be involved in any activity within the government marketplace provided through the system.

At block 604, if the system determines that the received data for a new user, the system further determines various attributes for that fulfilling organization. Some attributes are made visible within that fulfilling organization's profile, while others are utilized by the system to provide summarized analytics for the government procurement activities and the particular industries in which those activities take place. In some embodiments, the system can request a name for the fulfilling organization and a short description of the services offered. In other embodiments, the user can be provided with radio buttons which can provide various inputs and combinations thereof by which the system can analyze to determine attributes for the associated fulfilling organization. In yet another embodiment, the attributes are requested from the user in predefined fields, such as in a fillable registration form. The preferred attributes can include the name of the fulfilling organization, the industry or industries in which that fulfilling organization performs a service, and the location of the fulfilling organization. Each fulfilling organization can be an organization providing a service for compensation from a government agency.

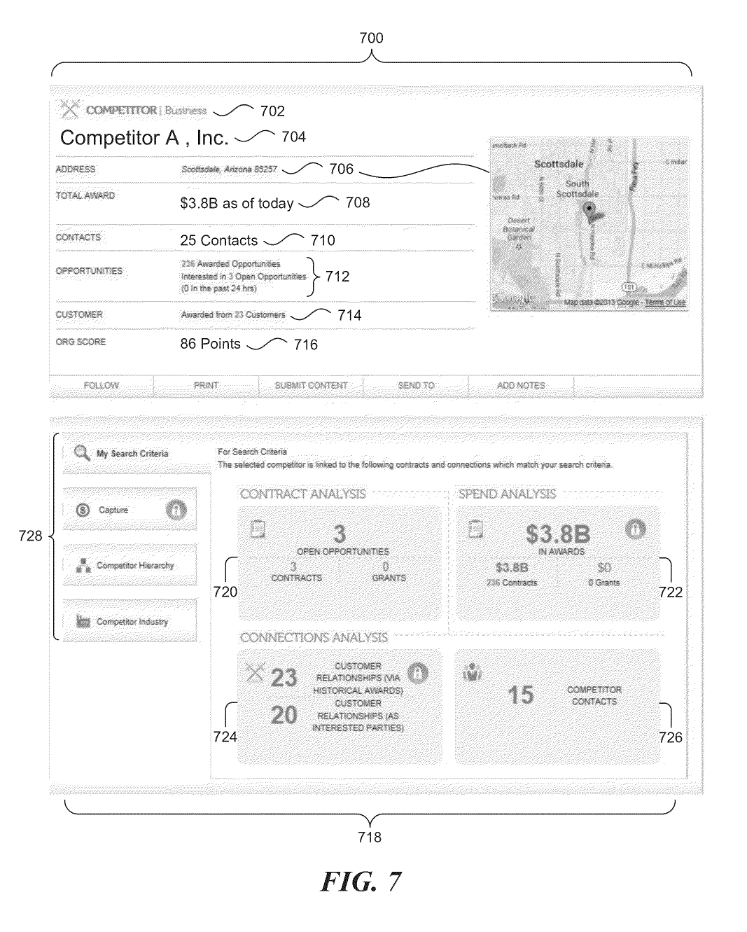

At block 606, the system can generate a profile for the fulfilling organization. An exemplary screenshot of profile for a fulfilling organization is illustrated in FIG. 7. The profile can include the basic attributes determined by the system during registration. For example, the attributes can include the name 704, location 706 and industry of the fulfilling organization. Other attributes includes in the profile can include, for example, the procurement opportunities 712 associated with that fulfilling organization 704, such as the past opportunities awarded or lost and the current opportunities for which a current bid has been placed or interest has been expressed. Subsequently, another attribute provided in the fulfilling organization profile can be the total compensation 708 received to date from opportunities awarded. Many of the predetermined attributes include in each fulfilling organization's profile will not have any input data upon initial registration of a fulfilling organization. Accordingly, these attribute fields may reflect a null input, e.g., provide no indication (blank) of related information, or may reflect a zero response, providing a “0” in each of the corresponding attribute fields.

The fulfilling organization profile also includes an “Org Score” 716 similar to the profile for a customer shown in and described with reference to FIG. 5. The “Org Score” can be initially null, set to zero “0,” or indicate “pending” when a fulfilling organization has not won and/or bid on any solicitations and has initially registered with the system. As the fulfilling organization successfully obtains procurement opportunities, the system generates an organization score based on those opportunities. In some embodiments, the organization score can change with each bid placed on a procurement opportunity. In other embodiments, the organization score only changes when a procurement opportunity is actually awarded to that organization.

As shown in FIG. 7, the fulfilling organization profile includes two sections, or windows in which the fulfilling organization is profiled based on fulfilling organization data received during registration and that fulfilling organization's performance in the marketplace. The overview of the fulfilling organization is provided in a first window 700, while the analytics associated with that fulfilling organization are provided in the second window 718. For example, the first window 700 can include the name 704, profile type 702, location (and corresponding visual location in a map) 706, the gross amount for awards received 708, a number of contacts 710, current and historical opportunity metrics 712, a number of customers associated with the awards received 714, and the organization score 716.

The second window 728, including the analytics particular to the fulfilling organization, can provide the user with a navigable interface for a particular type of metric analyzed as well as quick tab functions 728 to allow more visibility into fulfilling organization associated market data. As previously mentioned, the summaries of the analyzed data within the second window can be null or “0” prior to the existence of any market activity involving a newly registered fulfilling organization 704. For example, the contract analysis, spend analysis and connections analysis (customer and contacts) can each indicate a null status (or “pending”) after initial registration. As each of these numbers changes, however, the fulfilling organization score 716 will change as each of these attributes analyzed by the system in association with that fulfilling organization affects the overall rating, or score for that fulfilling organization 704. The user can also view the current industry or industries in which the fulfilling organization is associated to determine the current market for that organization. In some embodiments, the associated industry or industries can affect the fulfilling organization score 716.

Referring back to FIG. 6, at block 608, the system can receive an indication identifying an opportunity of interest for that fulfilling organization 704. The indication can include an input, such as a “follow” for a particular solicitation viewed in the government marketplace provided through the system. Additionally, the indication can be provided through a bid on a particular procurement activity, a notification of being outbid or losing an opportunity, or, simply performing a search of particular attributes associated with an opportunity and accessing that procurement opportunity profile. Dependent on the indication received, the system can then determine how the fulfilling organization score 716 will be affected by the interest in an opportunity. For example, if a user merely expresses interest in an opportunity, this will minimally affect that fulfilling organization's score. However, if the user representing the fulfilling organization 704 places a bid on the procurement opportunity, the score will ultimately be affected by the win or loss of that bid. Similarly, if a user “follows” multiple procurement opportunities, but never bids on an opportunity, the fulfilling organization's score may decrease over time. For example, if a fulfilling organization has never been awarded an opportunity, but is “interested in” 50 procurement opportunities in the industry for an extended period of time, e.g., six months, then the system may determine that the fulfilling organization is not a threat in the marketplace (or, is inactive). The system may then lower the score for that fulfilling organization each six months in which no bids are placed on numerous opportunities in which that fulfilling organization has expressed interest.

At block 610, the system determines if an opportunity of interest is pursued, or if a bid is placed on that opportunity. If no bid is placed, then the fulfilling organization's score can remain unchanged in the fulfilling organization's profile as shown at block 620. In some embodiments, as discussed in the previous paragraph, the fulfilling organization's score 716 can change even if a bid is not placed, but after a predetermined time interval of “inactivity” in the marketplace. However, if a bid has been placed on the opportunity, then the system can begin the process of determining a fulfilling organization score 716 for the fulfilling organization's profile. This score can be either an update to a previously calculated score (which is currently maintained in the fulfilling organization's profile), or, the first calculation of a fulfilling organization score based on the fulfilling organization's activity in the marketplace. In some embodiments, a mean score may be assigned to each newly registered fulfilling organization based on various attributes, e.g., size, location 706, industry, of that fulfilling organization. In other embodiments, the fulfilling organization does not have a score visible in its profile until activity, e.g., bidding, following, etc., has occurred. Accordingly, when a bid is placed, the system can analyze not only the industry data associated with the fulfilling organization 704 and the procurement opportunity, but also the various attributes of the opportunity in order to determine the score for the fulfilling organization.

At block 612, after a bid has been placed, the system determines the complexity of the opportunity from the procurement opportunity profile data. As previously discussed with reference to FIG. 3, the complexity score does not change and is determined once a new opportunity enters the market during generation of that opportunity profile. The complexity score can provide valuable data for the fulfilling organization score 716 and can be weighted more heavily than other attributes factored into that score. For example, a fulfilling organization bidding on an opportunity having a complexity score of 30 is valued much less than a fulfilling organization bidding on an opportunity having a complexity score of 87. Accordingly, the fulfilling organization's score 716 may increase 5% for the complexity score of 30 and 40% for a complexity score of 87.

At block 614, the system then determines the customer score of the government agency offering the procurement opportunity in the marketplace. The customer score can factor into the fulfilling organization score dependent on several attributes of that agency. However, the customer score is not as heavily weighted as the procurement opportunity complexity score for determining the fulfilling organization's score. If a customer is a large agency offering numerous procurement opportunities in the marketplace on a regular basis, a bid on an associated opportunity can increase the fulfilling organization's score. The increase occurs because, if the fulfilling organization provides a good service, the probability of future awards from that customer increases. Conversely, if the agency has a low customer score, based heavily on poor feedback and other attributes directly affecting the awarded fulfilling organization (e.g., delayed pay, long contract times, etc.), the fulfilling organization's score 716 may increase for winning a bid, but increase a lower percentage due to the associated customer's low score.

At bock 616, the industry in which the fulfilling organization is providing service is assessed to determine the current market, e.g., few opportunities available, difficulty in being awarded opportunity in that market, compensation in the market per opportunity, etc. Essentially, all the analytics are performed on a scheduled basis and provide the users of the system a means for determining the current market status in any of the predetermined eight (8) verticals, or industries and/or their associated sub-industries.

At block 618, the fulfilling organization's score is calculated based on the various attributes associated with that fulfilling organization, e.g., size, location, procurement opportunity history, current procurement opportunity win/loss, and associated customer scores and complexity scores from current and past bids. Each attribute can be factored into the score. At block 620, once the score is calculated, it is posted into the fulfilling organization's profile and maintained in the profile until further market activity associated with that fulfilling organization 704 occurs.

As previously mentioned, the fulfilling organization score 716 changes dynamically with each new data received by the system which is associated with that fulfilling organization. Specific attributes affect the score more profoundly, such as the win or loss of an opportunity bid and/or the amount of compensation for awarded bids. However, though the score changes based on specific activity involving that fulfilling organization 704, the score 716 can also be affected by the market in which that fulfilling organization 704 offers a service. For example, if a market collapse occurs in the life sciences industry, the fulfilling organization's “Org Score” may decrease to reflect less opportunity and likelihood of being compensated in that associated industry. Additionally, unlike the customer score, the fulfilling organization score 716 is not affected by other system users inputs, such as feedback and other sentiments expressed by the government agency awarding that opportunity. This is because, once the contract has been won by a fulfilling organization 704, the services performed and any corresponding details with that contract are no longer publicly available, e.g., known to the system. Accordingly, the analytics provided by the system for the government marketplace provide insight into this area by reflecting whether the fulfilling organization is awarded any additional opportunities in that specific industry or by that agency. Since government agencies may not provide feedback or utilize the system in a similar manner as the fulfilling organizations, this knowledge may be irrelevant to users within those agencies. However, for business in the same industry, this can allow fulfilling organizations to assess the likelihood that a fellow bidder will be awarded a contract for a particular procurement opportunity. Thus, the fulfilling organization analytics 718 and, specifically, the organization score 716 are important determinants for the fulfilling organizations when assessing industry markets and the competition for procurement opportunities.

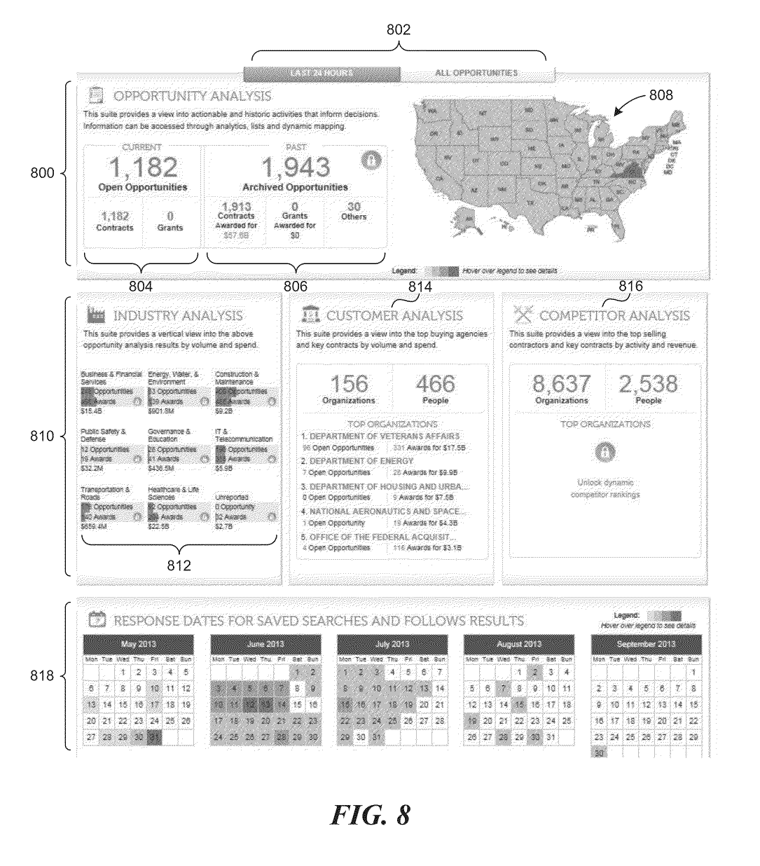

Referring to FIG. 8, an exemplary screenshot of the summarized analytics for the government marketplace is illustrated. The marketplace is divided into categories of analytics corresponding to: opportunities 800, industry 810, customer 814, and industry 816. Though each set of analytics are dependent on each other, e.g., scoring in the profiles and data shared across each entity actively participating in the marketplace, each set of analytics is tailored to system users. Primarily the analytics are tailored to fulfilling organizations in order to provide them with key information (e.g., contacts and place performance), trends and benchmarks in the aforementioned industries of interest. For example, fulfilling organizations can track the flow of capital (e.g., through awarded opportunities) in a specific industry in order to understand trends for that industry and pinpoint opportunities. Users can also evaluate trends on a customer by customer, e.g., Competitor Analysis 816, basis if interested in that particular customer's current or future procurement opportunities. In some industries and/or with some customers, for example, contracts (i.e., opportunities) are often re-competed annually. Furthermore, a fulfilling organization can gain insight into the best contractors (i.e., fulfilling organizations) available for that contract based on historic data in order to assess the competition.

A first analytics suite 800 provides a set of opportunity analytics provides the user with visual metrics for the currently available opportunities 804, including contracts and grants, for which data was received by the system. A second set of opportunity analytics provides the user with visual metrics for past, or archived opportunities 806, including contracts and grants, stored in the system and for which the associated data is indexed, analyzed and stored in various databases within the system. Additionally, a graphical representation of the location 808 of the currently available opportunities can be provided such that fulfilling organizations can determine where its business services may provide the best return. Further, a time slider (not shown) can be provided to users who have entered at least one search criteria, such as a search term, and can provide an adjustable time period over which a user can analyze the data according to the entered criteria. In a further embodiment, a user can have visibility into the procurement opportunity analytics over predetermined time intervals 802, e.g., twenty-four (24) hours, or, over the entire procurement opportunity history of the marketplace on the system. For example, if a new user wants to establish itself in the marketplace that user may choose to review analytics relating to all opportunities in order to gain knowledge of the market prior to placing a bid. Conversely, an established user (e.g., one that has a complete profile with bids, losses, wins, contacts, etc.), may wish only to view new opportunity data and analytics in order to determine which procurement opportunities are worth pursuing. The opportunity data in an opportunity profile, current or archived, may not change as a result of new data associated with fulfilling organization(s) and customer(s) referenced in that profile being received by the system. However, the new data associated with the fulfilling organization and customer data can still be accessible through that opportunity profile. For example, if an archived opportunity profile provided by Agency A included a small compensation for a rudimentary service to be performed and a user wanted to see the possible growth of company A since that procurement opportunity was awarded, the user could access the company A profile through the archived opportunity profile. The access to company A profile could reflect that multiple opportunities of increasing compensation and complexity had been received.

Three additional analytics suites including industry analytics 810, customer analytics 814 and fulfilling organization analytics 816 are provided in separate windows. Each suite includes a summarized overview of the main categories utilized by the system to organize the government market related data for analysis. These categories include the industry 810, customers (government agencies) 814 and fulfilling organizations 816 (businesses/contractors). As discussed in previous paragraphs the opportunity data 800 is also a category for which an analytics suite is provided on the analytics overview.

The industry analysis window 810 can provide an overview of the opportunities awarded in each of the eight verticals 812 into which the opportunity data is categorized. Each of the eight verticals 812 provides a summarized graph of opportunities, opportunities awarded and the total spending in that industry. The information is taken from the aggregated data utilized to provide the opportunities analysis in the first window providing the procurement opportunities overview. The industry analysis window 810 can further provide a system user with an idea of the industry in which the highest spending is occurring, which can subsequently allow the user to determine the probable complexity of the contracts, e.g., higher spending with low volume of awarded opportunities versus high spending and high volume of awarded opportunities. For example, as shown in the industry analytics window, high spending is occurring in the IT and Telecommunications vertical and Healthcare and Life Sciences window. Each of the aforementioned windows has a comparative amount of awarded opportunities, but the spending in the Life Sciences industry is over 50% higher than in the IT and Telecom industry. This indicates a higher contract price, which may further indicate a higher complexity score for those contracts.

The customer analysis window 814 provides an overview of the suite of customer analytics utilized to analyze the procurement opportunities received by the system. The overview provides the top buying government agencies, both historically (e.g., when “All Opportunities” button is selected) and daily (e.g., when “Last 24 Hours” button is selected). Additionally, it provides a summary of those top agencies including the number of current open opportunities and the historical spend amount for awarded opportunities. From the customer analysis window 814, a system user can gain insight into the customers, or government agencies, which have the highest organization scores, dependent on the ranking within that window. System users can also view how many customers and available contacts are within the system.

The fulfilling organization analysis window 816 provide an overview of the suite of fulfilling organization analytics provides a summary of the top fulfilling organizations in the system and the contracts received by those fulfilling organizations. Additionally, the aggregate number of fulfilling organizations currently known to the system and those fulfilling organization contacts, e.g., “People”, are also shown. Similar to the customer analysis window, the fulfilling organization analysis window 816 offers a quick summary of the top fulfilling organizations by the number of current opportunities awards and the amount awarded. In most cases, the top ranking fulfilling organizations have higher organization scores. However, some fulfilling organizations may have few contracts which are highly complex but still fail to meet the awarded amount associated with other fulfilling organizations. In such a case, the fulfilling organization analytics suite may additionally weight the awarded amount per contract such that those organizations are located in the top rankings organizations.

Additionally on the summarized analytics overview page, the user can be provided with a calendar 818 of the response dates, or due dates to respond to procurement opportunities which that user has expressed interest, e.g., via a bid or by following that procurement opportunity profile. The due dates for each opportunity can provide another attribute to determining the complexity, customer and fulfilling organization scores. For example, if the due date for a procurement opportunity is reasonable for that particular opportunity (as assessed by the system based on other opportunity attributes), then the complexity score may be unaffected or decrease. However, for rush services to be performed, the complexity score may increase as providing that service becomes increasingly more difficult. As well, the score for the customer may decrease if, for example, a procurement opportunity is nearing a due date and has not received bids.

The fulfilling organizations can also utilize the calendar 818 to determine when the majority of contracts have due dates. For example, if a budgeted amount of money has to be spent by a government agency before June 20th, then the majority of the opportunities on the market may have June 20th as a due date for that opportunity. Accordingly, the agency is able to procure the service and allow for that spending prior to the due date. Trends in the government marketplace can then be analyzed to determine certain days, weeks or months in which a higher number of procurement opportunities have due dates and, thus, improved likelihood of a bid being accepted.

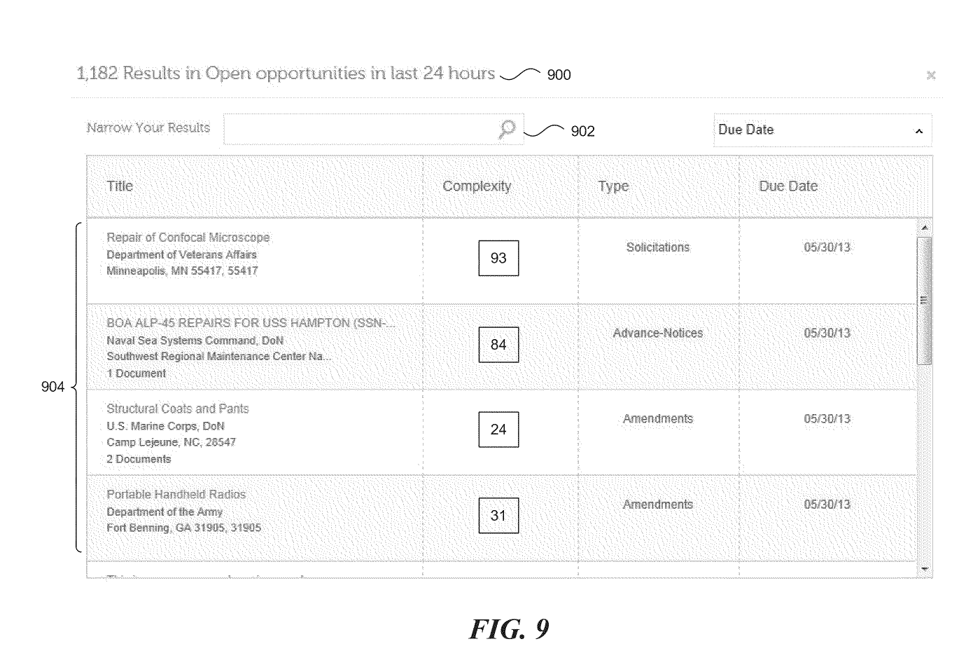

FIG. 9 illustrates an embodiment of a procurement opportunity list 900. The list may be generated, for example, when a user selects the “Open Opportunities” 804 shown in FIG. 8. The “Open opportunities” list 900 can provide a scrollable listing 904 of all the opportunities and related postings pertaining to a selected category, such as “Archived Opportunities” 806, one of the “Top Organizations” opportunities in the Customer Analysis 814 section, or industry-specific opportunities 812. The list 900 can also provide a search function 902 with an open text field for a user to perform a word and/or phrase search for various types of opportunities, updates related to awarded opportunities, and/or opportunities of interest. For example, an opportunity “Type” column provides a description of whether an opportunity qualifies as a “Solicitation”, “Amendment”, “Advance-Notices”, etc. as shown in FIG. 9.

Additional information provided in the “Open opportunities” listing 900 can include a “Title” column providing a procurement opportunity title, the name of the customer, or government agency, offering the procurement opportunity, the location, and the number of documents provided in the posting. A “Due Date” column can indicate a due date for opportunity fulfillment and a “Complexity Score” column can indicate the complexity of the corresponding procurement opportunity as discussed previously with reference to FIG. 3 and FIG. 5. Accordingly, with just four columns of opportunity data, a fulfilling organization can easily determine which procurement opportunities to review in further detail. For example, if a small construction company view a posting for a construction-related opportunity of high complexity and upcoming due date, that organization could easily skip a full review of that opportunity profile and move to the next.

Those skilled in the art will appreciate that the actual implementation of the data storage area may take a variety of forms, and the phrase “database” is used herein in the generic sense to refer to any area that allows data to be stored in a structured and accessible fashion using such applications or constructs as relational databases, tables, linked lists, arrays, flat files, and so on. Those skilled in the art will further appreciate that the depicted flow charts may be altered in a variety of ways. For example, the order of the steps may be rearranged, steps may be performed in parallel, steps may be omitted, or other steps may be included.

From the foregoing, it will be appreciated that specific embodiments of the invention have been described herein for purposes of illustration, but that various modifications may be made without deviating from the scope of the invention. Accordingly, the invention is not limited except as by the appended claims.

1. A computer-implemented method for calculating a complexity score of a procurement opportunity in a government marketplace, the method comprising:
compiling, on a server computer, data for a plurality of industries, wherein industry data comprises data relating to current procurement opportunities offered in a government marketplace and associated with each industry, historical procurement opportunities offered in the government marketplace and associated with each industry, and data concerning historical due dates of procurement opportunities associated with each industry;
retrieving, on by the server computer, opportunity data corresponding to a selected one of the current procurement opportunity opportunities in the government marketplace, the procurement opportunity being associated with a government agency and the opportunity data including a plurality of attributes;
on a processor of the server computer:
evaluating the opportunity data to identify the plurality of attributes,
wherein the plurality of attributes correspond to a predefined set of attributes associated with the government marketplace, and
wherein the plurality of attributes comprises a description of the selected procurement opportunity and an estimate of worker resources associated with the selected procurement opportunity;
identifying from the opportunity data an industry associated with the selected procurement opportunity, keywords associated with the selected procurement opportunity, and additional documents associated with the selected procurement opportunity;
analyzing the description associated with the selected procurement opportunity in order to estimate the difficulty of the selected procurement opportunity, wherein the estimated difficulty is based on keywords identified in the opportunity data and the number of additional documents;
calculating a complexity score of the selected procurement opportunity based on the estimated worker resources, the estimated difficulty based on the analyzed description, the government agency associated with the selected procurement opportunity, and the data for the identified industry associated with the selected procurement opportunity; and
presenting, on a display, the complexity score to a fulfilling organization to allow the fulfilling organization to assess the selected procurement opportunity.

2. The method of claim 1, further comprising:
determining if a customer profile corresponding to the government agency is stored in a database coupled to the server computer; and
if the customer profile is not stored in the database,
evaluating agency data associated with the government agency to identify one or more attributes of the government agency,
wherein the one or more attributes correspond to the predefined set of attributes;
generating the customer profile for the government agency, and
storing the generated customer profile in the database.

3. The method of claim 1, wherein the selected procurement opportunity includes a government grant or a government contract.

4. The method of claim 1, wherein the plurality of attributes further comprises a geographical location of the selected procurement opportunity, a compensation value of the selected procurement opportunity, or an industry of the selected procurement opportunity.

5. (canceled)

6. The method of claim 1, wherein the industry data further comprises aggregated complexity scores associated with each industry, and wherein the method of claim 1 further comprises, on the processor of the server computer:
evaluating the complexity scores for each of the current and past procurement opportunities in the industry data;
generating aggregated complexity scores associated with each industry based on the evaluated complexity scores; and
weighting the complexity score of the selected procurement opportunity based on the aggregated complexity score for the identified industry associated with the selected procurement opportunity and based on a customer score associated with the government agency from which the selected procurement opportunity originated.

7. The method of claim 1, wherein the government marketplace provides opportunity in eight or more predetermined industries.

8. The method of claim 1, further comprising: calculating, by the processor, a score for the government agency, the score based on at least a location of the agency, the opportunity data, the complexity score, and industry data.

9. The method of claim 1, further comprising: assigning a preliminary score to the fulfilling organization, wherein the preliminary score is one of a previously calculated score stored on a database coupled to the server computer or a mean score for the associated industry and location of the fulfilling organization.

10. The method of claim 1, further comprising, by the processor:
detecting one ore more documents are appended to the selected procurement opportunity;
determining a document type and a document size for each of the one or more documents; and
adjusting the complexity score based on the detection of the one or more documents, the document type and the document size.

11. A method implemented by a computing system for generating a customer score for a government agency offering at least one procurement opportunity in a government marketplace, the method comprising:
receiving opportunity data through a network interface on a computer, the opportunity data originating from government agencies and including one or more procurement opportunities;
selecting a government agency for which to calculate a customer score;
analyzing the received opportunity data over a plurality of criteria including:
a recency of one or more awarded opportunities in the government marketplace and the most recently awarded opportunity by the selected government agency;
a number of opportunities awarded by the selected government agency over a predetermined time interval; and
a monetary value for each opportunity awarded by the selected government agency to define a collective expenditure value over the predetermined time interval; and
calculating the customer score based on the plurality of criteria; and
presenting the customer score to facilitate assessment of the government agency.

12. The method of claim 11, further comprising: weighting each of the criteria prior to calculating the customer score.

13. The method of claim 11, wherein the customer score is a numerical score.

14. A non-transitory computer readable medium having instruction stored thereon that when executed by a processor perform the operations of:
receiving, on a computing system, opportunity data corresponding to a procurement opportunity in a government marketplace, the procurement opportunity being associated with a government agency and the opportunity data including two or more attributes;
evaluating the opportunity data to identify the attributes corresponding to a predefined set of attributes, the attributes including at least a compensation value and a description associated with the procurement opportunity;
analyzing the description associated with the procurement opportunity in order to estimate the difficulty of the procurement opportunity; and
calculating the complexity score of the procurement opportunity based on the one or more attributes.

15. The non-transitory computer readable medium of claim 14, further comprising:
generating an opportunity profile for the procurement opportunity, wherein the opportunity profile includes at least the complexity score, the associated industry, the geographical location, the name of the government agency, and the description.

16. The computer readable medium of claim 14, wherein the processor further performs the operations of:
analyzing the description for an indication of one or more industries associated with the procurement opportunity;
aggregating industry data in one of the indicated industries, the industry data including activity data relating to both current and historical procurement opportunities in the government marketplace; and
calculating the complexity score of the procurement opportunity based on the industry data.

17. A computer implemented method for determining an organization score for a fulfilling organization in a government marketplace, the method comprising:
receiving data corresponding to a fulfilling organization through a network interface on a computer, the data including one or more awarded procurement opportunities;
analyzing the received data over a plurality of criteria including:
an elapsed time period between the most recently awarded opportunity in the government marketplace and the most recently awarded opportunity to the fulfilling organization;
a number of opportunities awarded to the fulfilling organization over a predetermined time interval; and
a summation of monetary value for each opportunity awarded over the predetermined time interval;
calculating the fulfilling organization score based on the plurality of criteria; and
displaying the fulfilling organization score.

18. The method of claim 17, wherein the fulfilling organization score is a numerical value.

19. The method of claim 17, further comprising:
generating a profile for the fulfilling organization on the computer; and
determining a geographical location and an industry associated with the fulfilling organization, wherein the geographical location and the associated industry are included in the generated profile.

20. The method of claim 19, further comprising:
receiving an input from the fulfilling organization indicating interest in a procurement opportunity;
retrieving a complexity score for the procurement opportunity;
retrieving a customer score for the customer offering the procurement opportunity;
assessing data for the industry associated with the fulfilling organization; and
further using at least one of the complexity score, customer score, associated industry data, and location of the fulfilling organization in the calculation of the fulfilling organization score.

21. The method of claim 17, further comprising:
determining a compensation associated with each awarded procurement opportunity; and
calculating the fulfilling organization score based at least in part on the associated compensation.

22. The method of claim 17, further comprising:
determining whether feedback data associated with the fulfilling organization has been provided by registered users, the feedback data pertaining to at least one procurement opportunity fulfilled by the fulfilling organization;
assessing the feedback data for information characterizing the past performance of the fulfilling organization, wherein the information is assessed by searching for keywords reflecting sentiment; and
weighting the organization score based on the assessed feedback data.

23. A non-transitory computer readable medium encoded with instructions that when performed by a processor implement a method comprising:
compiling data for a plurality of industries, wherein industry data comprises data relating to current procurement opportunities offered in a government marketplace and associated with each industry, historical procurement opportunities offered in the government marketplace and associated with each industry, and data concerning historical due dates of procurement opportunities associated with each industry;
evaluating opportunity data maintained on a server computer in order to identify a plurality of attributes,
wherein the opportunity data corresponds to a procurement opportunity selected from one of the current procurement opportunities in the government marketplace, the procurement opportunity being associated with a government agency,
wherein the plurality of attributes correspond to a predefined set of attributes associated with the government marketplace, and
wherein the plurality of attributes comprises a description of the selected procurement opportunity and an estimate of worker resources associated with the selected procurement opportunity;
identifying from the opportunity data an industry associated with the selected procurement opportunity, keywords associated with the selected procurement opportunity, and additional documents associated with the selected procurement opportunity;
analyzing the description associated with the selected procurement opportunity in order to estimate the difficulty of the selected procurement opportunity, wherein the estimated difficulty is based on keywords identified in the opportunity data and the number of additional documents;
calculating a complexity score of the selected procurement opportunity based on at least the estimated worker resources, the estimated difficulty based on the analyzed description, the government agency associated with the selected procurement opportunity, and the data for the identified industry associated with the selected procurement opportunity; and
presenting, on a display, the complexity score to a fulfilling organization to allow the fulfilling organization to assess the selected procurement opportunity.

24. The non-transitory computer readable medium of claim 23, further comprising instructions for the processor to calculate a score for the government agency, wherein the score is based on at least a location of the government agency, the opportunity data, the complexity score, and industry data.

25. The non-transitory computer readable medium of claim 23, wherein the method further comprises: assigning a preliminary score to the fulfilling organization, wherein the preliminary score is one of a previously calculated score stored on a database coupled to the server computer or a mean score for the associated industry and location of the fulfilling organization.

26. The non-transitory computer readable medium of claim 23, wherein the selected procurement opportunity includes a government grant or a government contract.

27. The non-transitory computer readable medium of claim 23, wherein the plurality of attributes further comprises a geographical location of the selected procurement opportunity, a compensation value of the selected procurement opportunity, or an industry of the selected procurement opportunity.

28. A system for calculating a complexity for a procurement opportunity in a government marketplace, the system comprising:
a network interface;
a server computer coupled to the network interface and including:
one or more processors;
a data aggregating and index module configured to:
select opportunity data from a database, the opportunity data corresponding to a procurement opportunity from a plurality of current procurement opportunities in a government marketplace, wherein the procurement opportunity is associated with a government agency;
evaluate the opportunity data to identify a plurality of attributes, wherein the plurality of attributes correspond to a predefined set of attributes associated with the government marketplace, and wherein the plurality of attributes comprises a description of the selected procurement opportunity and an estimate of worker resources associated with the selected procurement opportunity;
identify from the opportunity data an industry associated with selected procurement opportunity, keywords associated with the selected procurement opportunity, and additional documents associated with the selected procurement opportunity; and
analyze the description associated with the selected procurement opportunity in order to estimate the difficulty of the selected procurement opportunity, wherein the estimated difficulty is based on keywords identified in the opportunity data and the number of additional documents; and
a complexity score generation module configured to calculate the complexity score of the selected procurement opportunity based on at least the estimated worker resources, the estimated difficulty based on the analyzed description, the government agency associated with the selected procurement opportunity, and data for the identified industry associated with the selected procurement opportunity; and
the database, coupled to the server computer, the database configured to store the current opportunity data and historical opportunity data, and further configured to compile data for a plurality of industries, wherein industry data comprises data relating to current procurement opportunities in the government marketplace and associated with each industry, historical procurement opportunities offered in the government marketplace and associated with each industry, and data concerning historical due dates of a procurement opportunities associated with each industry.

29. The system of claim 28, wherein the selected procurement opportunity includes a government grant or a government contract.

30. The system of claim 28, wherein the plurality of attributes further comprises a geographical location of the selected procurement opportunity, a compensation value of the selected procurement opportunity, or an industry of the selected procurement opportunity.

31. The system of claim 28, wherein the government marketplace provides opportunities in eight or more predetermined industries.

32. The system of claim 28, further comprising: an organization score generation module configured to calculate a score for the government agency, wherein the score is based on at least a location of the government agency, the opportunity data, the complexity score, and industry data.
